(19) United States
(12) Patent Application Publication
(10) Pub. No.: US 2024/0071326 A1
(43) Pub. Date: Feb. 29, 2024

(54) DISPLAY DEVICE AND DISPLAY METHOD THEREOF

(71) Applicant: Qisda Corporation, Taoyuan City (TW)

(72) Inventor: Chun-Chang Wu, Taoyuan City (TW)

(73) Assignee: Qisda Corporation, Taoyuan City (TW)

(21) Appl. No.: 18/336,921

(22) Filed: Jun. 16, 2023

(30) Foreign Application Priority Data
Aug. 23, 2022 (CN) 202211011863.X

(51) Int. Cl. G09G 3/36

(52) U.S. Cl. CPC G09G 3/36; G09G 2320/0252; G09G 2320/041; G09G 2320/048; G09G 2320/08; G09G 2340/0435; G09G 2360/145

(57) ABSTRACT

A display device and a display method thereof are provided. A sensing module senses at least one state parameter of a display unit. A control circuit stores a plurality of overdrive characteristic lookup tables, selects and calculates an overdrive lookup table according to an overdrive characteristic corresponding to the at least one state parameter and a working parameter of the display unit, and controls the display unit to display according to the overdrive lookup table.

### CROSS-REFERENCE TO RELATED APPLICATION

This application claims the priority benefit of China application serial no. 202211011863.X, filed on Aug. 23, 2022. The entirety of the above-mentioned patent application is hereby incorporated by reference herein and made a part of this specification.

### BACKGROUND

### Technical Field

The disclosure relates to an electronic device, and in particular, relates to a display device and a display method thereof.

### Description of Related Art

When a liquid crystal display displays moving images, image motion blur may occur as affected by the pixel response time of the liquid crystal. As such, overdrive and motion blur reduction technology are adopted most of the time to improve the image quality of the displays. In order to optimize the image quality of a display, it is necessary to perform multiple gray-to-gray time-domain waveform measurements on the display in advance and then optimize the overdrive lookup table stored in the display through an algorithm.

However, such an adjustment method is time-consuming and requires the use of expensive equipment and software. Therefore, the factory-made displays generally are not equipped with the function for allowing the user to adjust the overdrive lookup table. However, there are many factors that affect the response time of liquid crystal pixels, such as liquid crystal alignment mode, screen refresh rate, temperature, and aging. If the overdrive lookup table is not adjusted according to the current parameters of a display, blurring, smearing, or ghosting problems are prone to occur.

### SUMMARY

The disclosure provides a display device and a display method thereof capable of improving the display quality of the display device.

The disclosure provides a display device including a display unit, a sensing module, and a control circuit. The sensing module senses at least one state parameter of the display unit. The control circuit is coupled to the display unit and the sensing module, stores a plurality of overdrive characteristic lookup tables, selects and calculates an overdrive lookup table according to an overdrive characteristic corresponding to the at least one state parameter and a working parameter of the display unit, and controls the display unit to display according to the overdrive lookup table.

In an embodiment of the disclosure, the sensing module includes a light sensor and an amplifier circuit. The light sensor senses a grayscale frame displayed by the display unit to generate a corresponding light sensing signal. The amplifier circuit is coupled to the light sensor and the control circuit and amplifies the light sensing signal generated by the light sensor to generate a corresponding amplified signal. The control circuit updates the overdrive characteristic lookup tables according to a change of the amplified signal. The amplified signal changes from a first amplified signal corresponding to a first grayscale frame to a second amplified signal corresponding to a second grayscale frame.

In an embodiment of the disclosure, the amplifier circuit includes an operational amplifier, a switching circuit, and a plurality of feedback resistors. Positive and negative input terminals of the operational amplifier are respectively coupled to a reference voltage and the light sensor, and an output terminal of the operational amplifier is coupled to the control circuit. The switching circuit is coupled to an output terminal of the operational amplifier. The plurality of feedback resistors are coupled between the switching circuit and the negative input terminal of the operational amplifier. The plurality of feedback resistors have different resistance values. The control circuit outputs a switching control signal according to grayscale values of the first grayscale frame and the second grayscale frame, so as to control the switching circuit to connect one of the feedback resistors to the output terminal of the operational amplifier, so that signal values of the first amplified signal and the second amplified signal fall within a predetermined range.

In an embodiment of the disclosure, the at least one state parameter includes a temperature of the display unit. The sensing module includes a temperature sensor sensing the temperature of the display unit to generate a temperature sensing signal.

In an embodiment of the disclosure, the temperature sensor and the switching circuit share an I2C pin for transmitting the temperature sensing signal or the switching control signal.

In an embodiment of the disclosure, a linear relationship is provided among the overdrive characteristic lookup tables corresponding to different temperatures of the display unit. The control circuit, according to an updated overdrive characteristic lookup table and the linear relationship, updates the remaining overdrive characteristic lookup tables.

In an embodiment of the disclosure, the overdrive characteristic lookup tables are divided into a plurality of groups of overdrive characteristic lookup tables according to different overdrive setting values. The control circuit updates each group of overdrive characteristic lookup tables with different overdrive setting values.

In an embodiment of the disclosure, the working parameter includes a frame refresh rate of an image frame displayed by the display unit, and the at least one state parameter includes the temperature of the display unit.

In an embodiment of the disclosure, the at least one state parameter further includes an aging degree of the display unit.

In an embodiment of the disclosure, the plurality of overdrive characteristic lookup tables include a plurality of response time characteristic lookup tables and a plurality of overshoot characteristic lookup tables.

The disclosure further provides a display method of a display device. The display device includes a sensing module, and the display device stores a plurality of overdrive characteristic lookup tables. The display method of the display device includes the following steps. The sensing module senses at least one state parameter of the display device. An overdrive lookup table is selected and calculated according to an overdrive characteristic corresponding to the at least one state parameter and a working parameter of the display device. The display device is controlled to display according to the overdrive lookup table.

In an embodiment of the disclosure, the sensing module includes a light sensor and an amplifier circuit. The display method of the display device includes the following steps. The light sensor senses a grayscale frame displayed by the display device to generate a corresponding light sensing signal. The amplifier circuit amplifies the light sensing signal generated by the light sensor to generate a corresponding amplified signal. The overdrive characteristic lookup tables are updated according to a change of the amplified signal. The amplified signal changes from a first amplified signal corresponding to a first grayscale frame to a second amplified signal corresponding to a second grayscale frame.

In an embodiment of the disclosure, the amplifier circuit includes an operational amplifier, a switching circuit, and a plurality of feedback resistors. Positive and negative input terminals of the operational amplifier are respectively coupled to a reference voltage and the light sensor. The switching circuit is coupled to an output terminal of the operational amplifier. The plurality of feedback resistors are coupled between the switching circuit and the negative input terminal of the operational amplifier. The plurality of feedback resistors have different resistance values. The display method of the display device includes the following steps. A switching control signal is provided according to grayscale values of the first grayscale frame and the second grayscale frame, so as to control the switching circuit to connect one of the feedback resistors to the output terminal of the operational amplifier, so that signal values of the first amplified signal and the second amplified signal fall within a predetermined range.

In an embodiment of the disclosure, the at least one state parameter includes a temperature of the display device. The sensing module includes a temperature sensor. The temperature sensor senses the temperature of the display device to generate a temperature sensing signal.

In an embodiment of the disclosure, the temperature sensor and the switching circuit share an I2C pin for transmitting the temperature sensing signal or the switching control signal.

In an embodiment of the disclosure, a linear relationship is provided among the overdrive characteristic lookup tables corresponding to different temperatures of the display device. The display method of the display device includes the following step. According to an updated overdrive characteristic lookup table and the linear relationship, the remaining overdrive characteristic lookup tables are updated.

In an embodiment of the disclosure, the overdrive characteristic lookup tables are divided into a plurality of groups of overdrive characteristic lookup tables according to different overdrive setting values. The display method of the display device includes the following step. Each group of overdrive characteristic lookup tables with different overdrive setting values is updated.

In an embodiment of the disclosure, the working parameter includes a frame refresh rate of an image frame displayed by the display unit, and the at least one state parameter includes the temperature of the display device.

In an embodiment of the disclosure, the at least one state parameter further includes an aging degree of the display device.

In an embodiment of the disclosure, the plurality of overdrive characteristic lookup tables include a plurality of response time characteristic lookup tables and a plurality of overshoot characteristic lookup tables.

To sum up, in the embodiments of the disclosure, the overdrive lookup table is selected and calculated according to the overdrive characteristic corresponding to the state parameter and the working parameter of the display device, and the display device is controlled to display according to the overdrive lookup table. In this way, by selecting and calculating the overdrive lookup table according to the overdrive characteristic corresponding to the state parameter and the working parameter of the display device, the overdrive lookup table may be effectively optimized for the state parameter and the working parameter of the display device, and the display quality of the display device is thus improved.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a display device according to an embodiment of the disclosure.

FIG. 2 is a schematic view of a display device according to another embodiment of the disclosure.

FIG. 3 is a schematic table of a response time characteristic lookup table according to an embodiment of the disclosure.

FIG. 4 is a schematic table of an overshoot characteristic lookup table according to an embodiment of the disclosure.

FIG. 5 is a schematic table of an overdrive lookup table according to an embodiment of the disclosure.

FIG. 6 is a schematic diagram of a sensing module and a control circuit according to an embodiment of the disclosure.

FIG. 7 is a schematic waveform graph of an amplified signal according to an embodiment of the disclosure.

FIG. 8 is a flow chart of a display method of a display device according to an embodiment of the disclosure.

FIG. 9 is a flow chart of an update method of an overdrive characteristic lookup table according to an embodiment of the disclosure.

### DESCRIPTION OF THE EMBODIMENTS

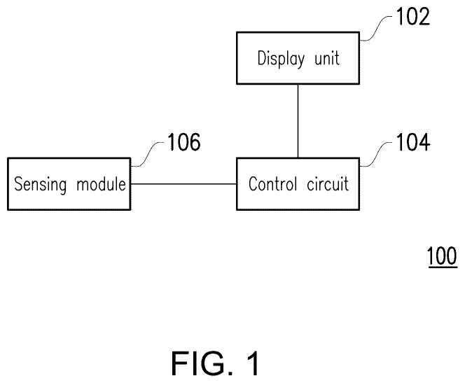

FIG. 1 is a schematic diagram of a display device according to an embodiment of the disclosure. With reference to FIG. 1, a display device 100 includes a display unit 102, a control circuit 104, and a sensing module 106. The control circuit 104 is coupled to the display unit 102 and the sensing module 106. The display unit 102 may be, for example, a liquid crystal display, but not limited thereto. The sensing module 106 may sense at least one state parameter of the display unit 102, such as a temperature of the display unit 102, but not limited thereto. The control circuit 104 stores a plurality of overdrive characteristic lookup tables corresponding to different state parameters and working parameters of the display unit 102. The working parameters may be, for example, a frame refresh rate of an image frame displayed by the display unit 102, but not limited thereto. The control circuit 104 may select and calculate an overdrive lookup table according to an overdrive characteristic corresponding to the state parameter and the working parameter of the display device 102 and may control the display unit 102 to display an image frame according to the selected and calculated overdrive lookup table. As such, by optimizing the overdrive lookup table for the state parameter and working parameter of the display unit 102, the control circuit 104 may control the display unit 102 to display an image frame according to the optimized overdrive lookup table, and the display quality of the display device may thus be improved.

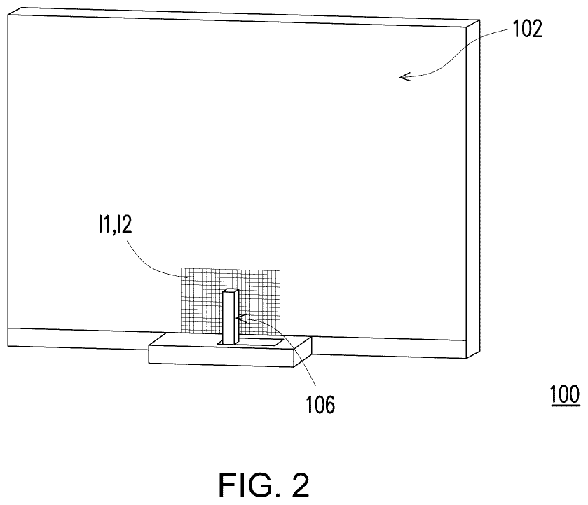

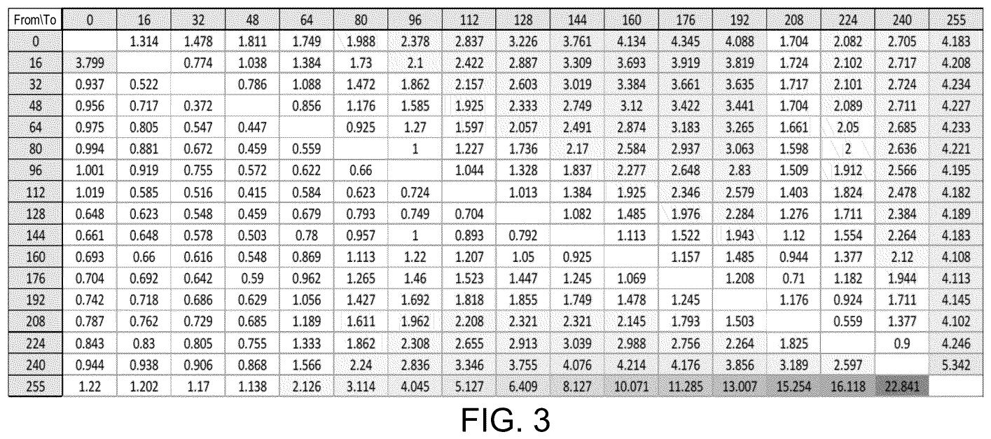

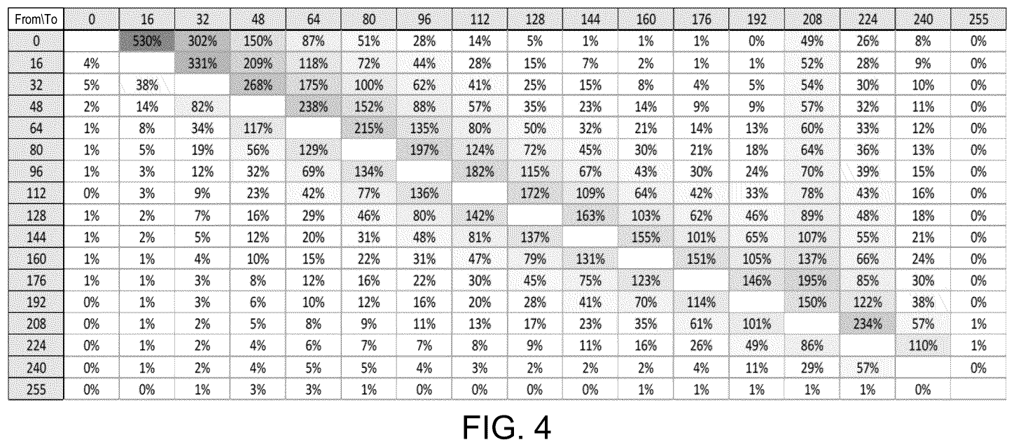

Further, the sensing module 106 may include a light sensor. As shown in FIG. 2, the sensing module 106 may be disposed in the display unit 102, may be lifted up when sensing a grayscale frame displayed on the display unit 102, and may be lowered to be accommodated in the display unit 102 (for example, accommodated in a base of the display unit 102, but not limited thereto) when not performing sensing. The display unit 102 may, for example, display a first grayscale frame I1 and a second grayscale frame 12 successively. The sensing module 106 may sense the first grayscale frame I1 and the second grayscale frame 12 to respectively generate a first light sensing signal and a second light sensing signal and may update the plurality of overdrive characteristic lookup tables stored in the control circuit 104 according to the first light sensing signal and the second light sensing signal. The overdrive characteristic lookup tables may include, for example, a response time characteristic lookup table as shown in FIG. 3 and an overshoot characteristic lookup table as shown in FIG. 4. That is, the control circuit 104 may store a plurality of response time characteristic lookup tables and a plurality of overshoot characteristic lookup tables.

The response time characteristic lookup table and the overshoot characteristic lookup table respectively shown in the embodiments of FIG. 3 and FIG. 4 are the response time characteristic lookup table and the overshoot characteristic lookup table corresponding to an overdrive setting value of 48. The control circuit 104 may store a plurality of groups of response time characteristic lookup tables and overshoot characteristic lookup tables corresponding to different overdrive setting values and may update each group of response time characteristic lookup tables and overshoot characteristic lookup tables with different overdrive setting values. Further, the total number of gray levels of the response time characteristic lookup table and the overshoot characteristic lookup table shown in the embodiments of FIG. 3 and FIG. 4 is 256 (0 to 255). However, in other embodiments, the total number of gray levels in the response time characteristic lookup table and the overshoot characteristic lookup table is not limited thereto.

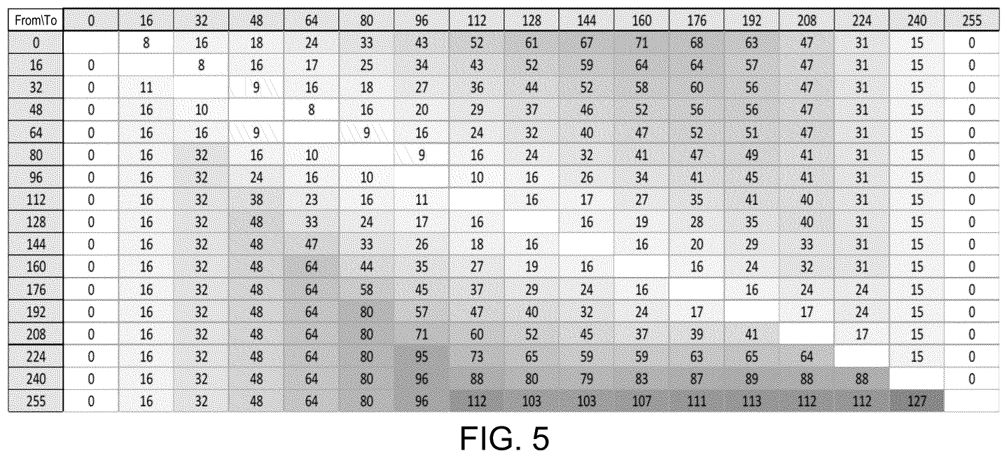

The control circuit 104 may set a target response time or a target overshoot percentage according to needs and may perform interpolation calculation according to the response time characteristic lookup table and the overshoot characteristic lookup table to obtain an overdrive lookup table corresponding to the target response time or the target overshoot percentage. For instance, FIG. 5 is an overdrive lookup table calculated by the control circuit 104 when the target overshoot percentage is set equal to 20%. The control circuit 104 may control the display unit 102 to display according to the overdrive lookup table to improve the display quality of the display unit 102. For instance, assuming that the grayscale value of the previous frame is 16 and the grayscale value of the current frame is 96, and from the overdrive lookup table in FIG. 5, it can be known that the overdrive setting value corresponding to the gray scale values from 16 to 96 is 34. Therefore, the control circuit 104 controls the display unit 102 to display an image with a grayscale value of 130 (96+34=130) instead to optimize the display quality of the display unit 102. In some embodiments, the control circuit 104 may also make the overdrive lookup table directly record the gray scale value 130 at the position corresponding to the gray scale values from 16 to 96.

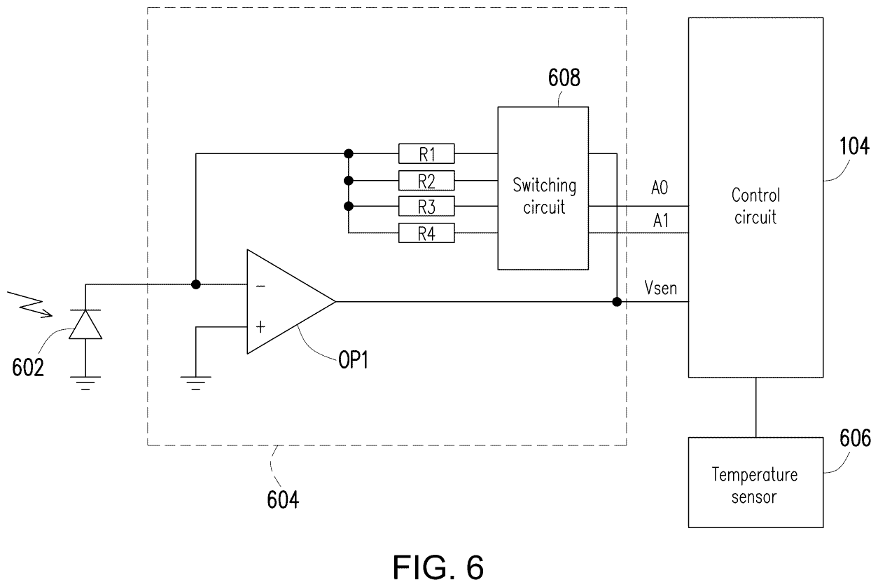

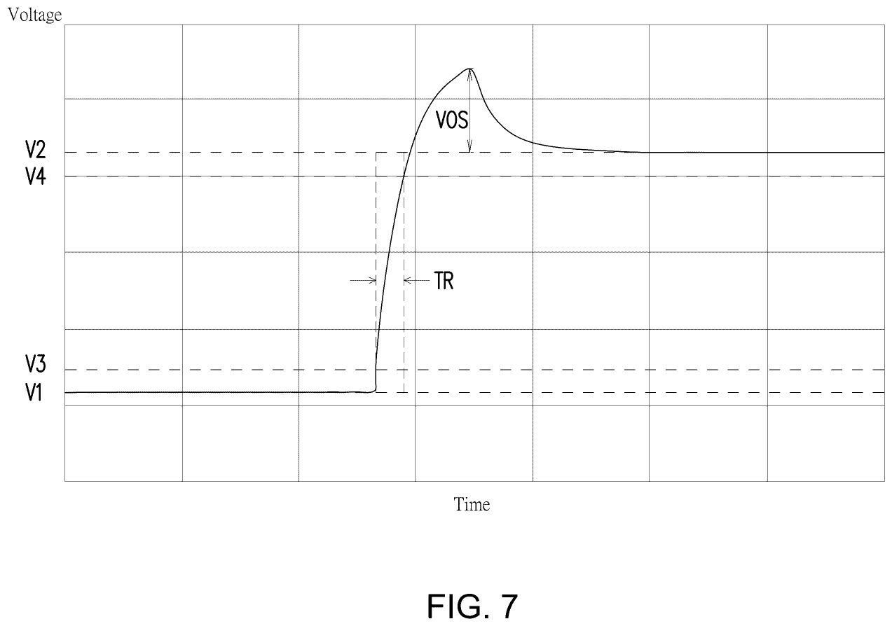

An implementation of the sensing module 106 may be shown in FIG. 6. In the embodiment of FIG. 6, the sensing module 106 may include a light sensor 602, and amplifier circuit 604, and a temperature sensor 606. The amplifier circuit 604 is coupled to the light sensor 602 and the control circuit 104, and the temperature sensor 606 is coupled to the control circuit 104. When the overdrive characteristic lookup tables are updated, the light sensor 602 may sense the first grayscale frame I1 and the second grayscale frame 12 displayed by the display unit 102 to respectively generate the first light sensing signal and the second light sensing signal. The amplifier circuit 604 may amplify the first light sensing signal and the second light sensing signal to generate a first amplified signal and a second amplified signal. The control circuit 104 may update the overdrive characteristic lookup tables according to the first amplified signal and the second amplified signal. It is worth noting that during the transition of the frame displayed by the display unit 102 from the first grayscale frame I1 to the second grayscale frame 12, the light sensor 602 continuously performs sensing to generate a light sensing signal corresponding to the change of the grayscale frame. Besides, the amplifier circuit 604 may also generate an amplified signal corresponding to the change of the grayscale image. For instance, as shown in FIG. 7, assuming that the voltages when the first amplified signal and the second amplified signal tend to be stable are V1 and V2 respectively, while the frame displayed by the display unit 102 transitions from the first grayscale frame I1 to the second grayscale frame 12, the output voltage of the amplifier circuit 604 changes from the voltage V1 to the voltage V2. When an output terminal of the amplifier circuit 604 changes from the first amplified signal to the second amplified signal, the control circuit 104 may calculate a response time TR for an output voltage of the amplifier circuit 604 to change from a voltage V3 to a voltage V4 and may calculate the overshoot percentage according to an overshoot voltage VOS and the voltages V1 and V2 to update the response time characteristic lookup tables and the overshoot characteristic lookup tables. The voltages V3 and V4 may be set, for example, to fall within 10% and 90% of the range from the voltage V1 to the voltage V2, but not limited thereto. In other embodiments, the voltages V3 and V4 may also be set to other voltage values.

To be specific, the amplifier circuit 604 may include an operational amplifier OP1, a switching circuit 608, and feedback resistors R1 to R4 as shown in FIG. 6. Positive and negative input terminals of the operational amplifier OP1 are respectively coupled to the ground and the light sensor 602, and an output terminal of the operational amplifier OP1 is coupled to the control circuit 104. The switching circuit 608 is coupled to the output terminal of the operational amplifier OP1 and the control circuit 104, and the feedback resistors R1 to R4 are connected in parallel between the switching circuit 608 and the negative input terminal of the operational amplifier OP1. The operational amplifier OP1 may amplify the light sensing signal provided by the light sensor 602 to generate an amplified signal Vsen. To ensure that the voltage value of the amplified signal Vsen falls within a predetermined range, the control circuit 104 may output a switching control signal to the switching circuit 608 according to the grayscale values of the first grayscale frame I1 and the second grayscale frame 12, so as to reflect the grayscale values of the first grayscale frame I1 and the second grayscale frame 12, control the switching circuit 608 to connect one of the feedback resistors R1 to R4 to the output terminal of the operational amplifier OP1, and prevent the amplified signal Vsen from falling outside the predetermined range. For instance, when a grayscale frame with a high grayscale value is to be measured, the control circuit 104 may control the switching circuit 608 to switch and connect the feedback resistor with a smaller resistance value to the output terminal of the operational amplifier OP1. When a grayscale frame with a low grayscale value is to be measured, the control circuit 104 then controls the switching circuit 608 to switch and connect the feedback resistor with a larger resistance value to the output terminal of the operational amplifier OP1 to ensure that the amplified signal Vsen falls within the predetermined range. Herein, the predetermined range may be set, for example, as an output dynamic range of the operational amplifier OP1, but not limited thereto. Further, the number of feedback resistors is not limited to this embodiment, and in other embodiments, the feedback resistors may include more or less resistors, and are not limited to 4 resistors.

The control circuit 104 may update the overdrive characteristic lookup tables or select and calculate the overdrive lookup table corresponding to different frame refresh rates and temperatures according to the frame refresh rate of the display unit 102 and the temperature sensing signal generated by the temperature sensor 606 sensing the temperature of the display unit 102. Further, it should be noted that since the overdrive characteristics may also vary with an aging degree of the display unit 102, in some embodiments, the control circuit 104 may update the overdrive characteristic lookup tables or select and calculate the overdrive lookup table according to the aging degree of the display unit 102. That is, the abovementioned state parameters may also include the aging degree of the display unit 102, but not limited thereto. In some embodiments, the state parameters may also include the arrangement of pixels of the liquid crystal display. Further, among the plurality of overdrive characteristic lookup tables stored in the control circuit 104, a linear relationship is provided among the overdrive characteristic lookup tables corresponding to different state parameters (e.g., corresponding to different temperatures) of the display unit 102. After completing one of the overdrive characteristic lookup tables, the control circuit 104 may, according to the updated overdrive characteristic lookup table and the linear relationship, update the remaining overdrive characteristic lookup tables, so that the overdrive characteristic lookup tables may be efficiently updated. Besides, in this embodiment, the control circuit 104 transmits the switching control signal to the switching circuit 608 through I2C pins A0 and A1. In some embodiments, the temperature sensor 606 may share the I2C pins A0 and A1 with the switching circuit 608 to transmit the temperature sensing signal, so that the number of pins may be reduced, which is beneficial to the miniaturization of the display device.

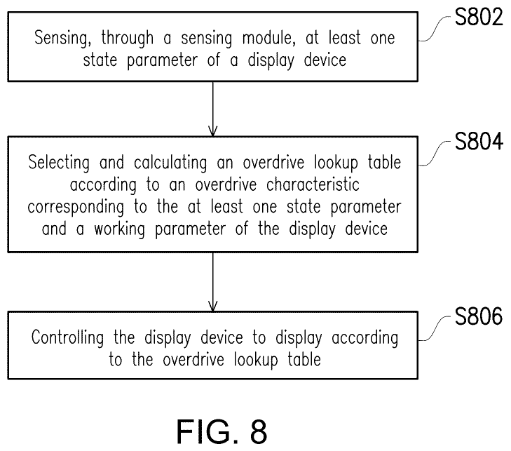

FIG. 8 is a flow chart of a display method of a display device according to an embodiment of the disclosure. The display device includes a sensing module and stores a plurality of overdrive characteristic lookup tables. These overdrive characteristic lookup tables may be divided into a plurality of groups of overdrive characteristic lookup tables according to different overdrive setting values, and the overdrive characteristic lookup tables may include a plurality of response time characteristic lookup tables and a plurality of overshoot characteristic lookup tables. As provided in the above embodiments, the display method of the display device may at least include the followings steps. First, the sensing module senses at least one state parameter of the display device (step S802). Herein, the sensing module may include, for example, a light sensor and a temperature sensor. The temperature sensor may sense a temperature of the display device to generate a temperature sensing signal. The state parameter may include, for example, the temperature and an aging degree of the display device, but not limited thereto. Next, an overdrive lookup table is selected and calculated according to an overdrive characteristic corresponding to the state parameter and a working parameter of the display device (step S804). The working parameter may be, for example, a frame refresh rate of an image frame displayed by the display device. The temperature sensor may only sense the current temperature of the display device. As such, in some embodiments, after the corresponding overdrive characteristic lookup table is updated according to the frame refresh rate and the current temperature of the display device, according to the updated overdrive characteristic lookup table and the linear relationship among the overdrive characteristic lookup tables corresponding to different temperatures of the display device, the remaining overdrive characteristic lookup tables may be updated. The remaining overdrive characteristic lookup tables are updated according to the updated overdrive characteristic lookup table and the linear relationship. The display device is then controlled to display according to the overdrive lookup table (step S806).

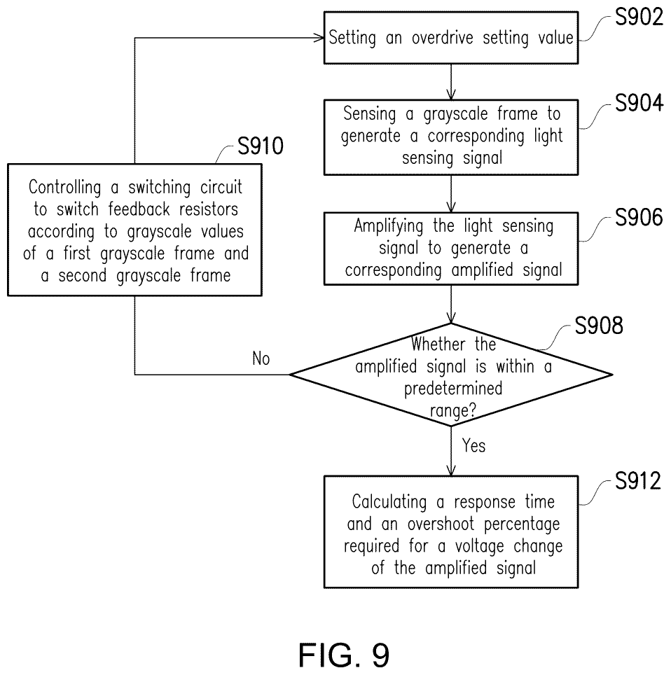

Further, the sensing module may also include an amplifier circuit. The amplifier circuit may include an operational amplifier, a switching circuit, and a plurality of feedback resistors with different resistance values as described in the abovementioned embodiments, and description of the coupling manner thereof is not repeated herein. It is worth noting that in some embodiments, the temperature sensor and the switching circuit may share I2C pins to reduce the number of pins, which is beneficial to the miniaturization of the display device. The method for updating each group of overdrive characteristic lookup tables with different overdrive setting values may be shown in FIG. 9. First, an overdrive setting value is set (step S902). Next, the light sensor senses a grayscale frame displayed by the display device and generates a corresponding light sensing signal (step S904). The amplifier circuit then amplifies the light sensing signal generated by the light sensor to generate a corresponding amplified signal (step S906). Herein, the amplified signal changes from the first amplified signal corresponding to the first grayscale frame to the second amplified signal corresponding to the second grayscale frame.

Next, it can be determined whether the first amplified signal and the second amplified signal fall within a predetermined range (step S908). If the first amplified signal or the second amplified signal does not fall within the predetermined range, the switching circuit may be controlled to switch the feedback resistors according to the grayscale values of the first grayscale frame and the second grayscale frame (step S910). That is, one of the plurality of feedback resistors is connected to the output terminal of the operational amplifier to ensure that the signal values of the first amplified signal and the second amplified signal fall within the predetermined range. Herein, the predetermined range may be, for example, the output dynamic range of the operational amplifier. If the first amplified signal and the second amplified signal fall within the predetermined range, the response time and overshoot percentage required for the voltage change of the amplified signal may be calculated (step S912) to update the overdrive characteristic lookup tables.

In view of the foregoing, in the embodiments of the disclosure, the overdrive lookup table is selected and calculated according to the overdrive characteristic corresponding to the state parameter and the working parameter of the display device, and the display device is controlled to display according to the overdrive lookup table. In this way, by selecting and calculating the overdrive lookup table according to the overdrive characteristic corresponding to the state parameter and the working parameter of the display device, the overdrive lookup table may be effectively optimized for the state parameter and the working parameter of the display device, and the display quality of the display device is thus improved.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A display device, comprising:
display unit;
a sensing module, sensing at least one state parameter of the display unit; and
a control circuit, coupled to the display unit and the sensing module, storing a plurality of overdrive characteristic lookup tables, selecting and calculating an overdrive lookup table according to an overdrive characteristic corresponding to the at least one state parameter and a working parameter of the display unit, and controlling the display unit to display according to the overdrive lookup table.

2. The display device according to claim 1, wherein the sensing module comprises:
a light sensor, sensing a grayscale frame displayed by the display unit to generate a corresponding light sensing signal; and
an amplifier circuit, coupled to the light sensor and the control circuit and amplifying the light sensing signal generated by the light sensor to generate a corresponding amplified signal, wherein the control circuit updates the overdrive characteristic lookup tables according to a change of the amplified signal, and the amplified signal changes from a first amplified signal corresponding to a first grayscale frame to a second amplified signal corresponding to a second gray scale frame.

3. The display device according to claim 2, wherein the amplifier circuit comprises:
an operational amplifier, wherein positive and negative input terminals thereof are respectively coupled to a reference voltage and the light sensor, and an output terminal of the operational amplifier is coupled to the control circuit;
a switching circuit, coupled to the output terminal of the operational amplifier; and
a plurality of feedback resistors, coupled between the switching circuit and the negative input terminal of the operational amplifier, wherein the feedback resistors have different resistance values, and the control circuit outputs a switching control signal according to grayscale values of the first grayscale frame and the second grayscale frame, so as to control the switching circuit to connect one of the feedback resistors to the output terminal of the operational amplifier, so that signal values of the first amplified signal and the second amplified signal fall within a predetermined range.

4. The display device according to claim 3, wherein the at least one state parameter comprises a temperature of the display unit, and the sensing module comprises:
a temperature sensor, sensing the temperature of the display unit to generate a temperature sensing signal.

5. The display device according to claim 4, wherein the temperature sensor and the switching circuit share an I2C pin for transmitting the temperature sensing signal or the switching control signal.

6. The display device according to claim 2, wherein a linear relationship is provided among the overdrive characteristic lookup tables corresponding to different temperatures of the display unit, and the control circuit, according to an updated overdrive characteristic lookup table and the linear relationship, updates the remaining overdrive characteristic lookup tables.

7. The display device according to claim 2, wherein the overdrive characteristic lookup tables are divided into a plurality of groups of overdrive characteristic lookup tables according to different overdrive setting values, and the control circuit updates each group of overdrive characteristic lookup tables with different overdrive setting values.

8. The display device according to claim 1, wherein the working parameter comprises a frame refresh rate of an image frame displayed by the display unit, and the at least one state parameter comprises a temperature of the display unit.

9. The display device according to claim 1, wherein the at least one state parameter further comprises an aging degree of the display unit.

10. The display device according to claim 1, wherein the overdrive characteristic lookup tables comprise a plurality of response time characteristic lookup tables and a plurality of overshoot characteristic lookup tables.

11. A display method of a display device, wherein the display device comprises a sensing module, the display device stores a plurality of overdrive characteristic lookup tables, and the display method of the display device comprises:
sensing, through the sensing module, at least one state parameter of the display device;
selecting and calculating an overdrive lookup table according to an overdrive characteristic corresponding to the at least one state parameter and a working parameter of the display device; and
controlling the display device to display according to the overdrive lookup table.

12. The display method of the display device according to claim 11, wherein the sensing module comprises a light sensor and an amplifier circuit, and the display method of the display device comprises:
sensing, through the light sensor, a grayscale frame displayed by the display device to generate a corresponding light sensing signal;
amplifying, through the amplifier circuit, the light sensing signal generated by the light sensor to generate a corresponding amplified signal; and
updating the overdrive characteristic lookup tables according to a change of the amplified signal, wherein the amplified signal changes from a first amplified signal corresponding to a first grayscale frame to a second amplified signal corresponding to a second grayscale frame.

13. The display method of the display device according to claim 12, wherein the amplifier circuit comprises an operational amplifier, a switching circuit, and a plurality of feedback resistors, positive and negative input terminals of the operational amplifier are respectively coupled to a reference voltage and the light sensor, the switching circuit is coupled to an output terminal of the operational amplifier, the feedback resistors are coupled between the switching circuit and the negative input terminal of the operational amplifier, the feedback resistors have different resistance values, and the display method of the display device comprises:
providing a switching control signal according to grayscale values of the first grayscale frame and the second grayscale frame, so as to control the switching circuit to connect one of the feedback resistors to the output terminal of the operational amplifier, so that signal values of the first amplified signal and the second amplified signal fall within a predetermined range.

14. The display method of the display device according to claim 13, wherein the at least one state parameter comprises a temperature of the display device, the sensing module comprises a temperature sensor, and the temperature sensor senses the temperature of the display device to generate a temperature sensing signal.

15. The display method of the display device according to claim 14, wherein the temperature sensor and the switching circuit share an I2C pin for transmitting the temperature sensing signal or the switching control signal.

16. The display method of the display device according to claim 12, wherein a linear relationship is provided among the overdrive characteristic lookup tables corresponding to different temperatures of the display device, and the display method of the display device comprises: updating, according to an updated overdrive characteristic lookup table and the linear relationship, the remaining overdrive characteristic lookup tables.

17. The display method of the display device according to claim 12, wherein the overdrive characteristic lookup tables are divided into a plurality of groups of overdrive characteristic lookup tables according to different overdrive setting values, and the display method of the display device comprises: updating each group of overdrive characteristic lookup tables with different overdrive setting values.

18. The display method of the display device according to claim 11, wherein the working parameter comprises a frame refresh rate of an image frame displayed by the display device, and the at least one state parameter comprises a temperature of the display device.

19. The display method of the display device according to claim 11, wherein the at least one state parameter further comprises an aging degree of the display device.

20. The display method of the display device according to claim 11, wherein the overdrive characteristic lookup tables comprise a plurality of response time characteristic lookup tables and a plurality of overshoot characteristic lookup tables.
